(19) United States
(12) Patent Application Publication
(10) Pub. No.: US 2021/0154769 A1
(43) Pub. Date: May 27, 2021

(54) THREE-DIMENSIONAL MANUFACTURING APPARATUS AND THREE-DIMENSIONAL MANUFACTURING METHOD

(71) Applicant: MITSUBISHI HEAVY INDUSTRIES, LTD., Tokyo (JP)

(72) Inventors: Hanami NAOKI, Tokyo (JP); Takahiro TACHIBANA, Tokyo (JP); Yasuyuki FUJIYA, Tokyo (JP); Takayuki TAKAHASHI, Tokyo (JP)

(21) Appl. No.: 16/950,121

(22) Filed: Nov. 17, 2020

(30) Foreign Application Priority Data
Nov. 27, 2019 (JP) 2019-213811

(51) Int. Cl. B23K 26/34; B33Y 30/00; B33Y 50/02; B33Y 10/00; B33Y 40/20; B23K 26/354

(52) U.S. Cl. CPC B23K 26/34; B33Y 30/00; B23K 26/354; B33Y 10/00; B33Y 40/20; B33Y 50/02

(57) ABSTRACT

A three-dimensional manufacturing apparatus according to at least one embodiment of the present disclosure includes: a manufacturing nozzle for melting a metal material with an energy beam while supplying the metal material to form a bead; a cooling medium nozzle for spraying a cooling medium toward a region including the bead in a workpiece so that the region is cooled locally; a temperature detection unit configured to detect at least a temperature of the region; and a control device for controlling at least one of a scanning rate of the cooling medium nozzle or an amount of the cooling medium to be sprayed per unit time based on a detection result from the temperature detection unit.

### CROSS-REFERENCE TO RELATED APPLICATIONS

This application claims the benefit of priority to Japanese Patent Application Number 2019213811 filed on Nov. 27, 2019. The entire contents of the above-identified application are hereby incorporated by reference.

### TECHNICAL FIELD

The present disclosure relates to a three-dimensional manufacturing apparatus and a three-dimensional manufacturing method.

### RELATED ART

Three-dimensional additive manufacturing methods are utilized as methods for producing various metal products. In the production of a metal product by a three-dimensional additive manufacturing method, a solid product is formed by melting a metal powder that serves as a material with an energy beam such as laser light, and then solidifying it. In recent years, there has been a demand for producing larger metal products by three-dimensional additive manufacturing methods (see, for example, JP 6405028 B).

### SUMMARY

In the manufacturing of a metal product by a three-dimensional additive manufacturing method, a metal powder that serves as a material is heated by an energy beam as described above, and, therefore, heat is easily accumulated in a workpiece. Furthermore, when the workpiece becomes larger as the manufacturing progresses, the heat capacity of the workpiece increases. In particular, when the workpiece to be manufactured is large, the workpiece is required to be manufactured at a high welding rate in order to shorten the manufacturing time. So, the amount of heat introduced into the workpiece tends to increase as the supplying rate of the material increases. As a result, the temperature of the workpiece becomes less likely to decrease as the manufacturing progresses, and there is a risk that the manufacturing time may increase due to the occurrence of a time to wait for the temperature of the workpiece to decrease during manufacturing, resulting in a decrease in production efficiency.

In light of the above circumstances, an object of at least one embodiment of the present disclosure is to improve production efficiency in three-dimensional additive manufacturing.

(1) A three-dimensional manufacturing apparatus according to at least one embodiment of the present disclosure includes:

a manufacturing nozzle for melting a metal material with an energy beam while supplying the metal material to form a bead;

a cooling medium nozzle for spraying a cooling medium toward a region including the bead in a workpiece so that the region is cooled locally;

a temperature detection unit configured to detect at least a temperature of the region; and

a control device for controlling at least one of a scanning rate of the cooling medium nozzle or an amount of the cooling medium to be sprayed per unit time based on a detection result from the temperature detection unit.

(2) A three-dimensional manufacturing method according to at least one embodiment of the present disclosure includes:

melting a metal material with an energy beam while supplying the metal material to form a bead; and

spraying a cooling medium toward a region including the bead in a workpiece so that the region is cooled locally.

According to at least one embodiment of the present disclosure, the production efficiency in three-dimensional additive manufacturing can be improved.

### BRIEF DESCRIPTION OF DRAWINGS

The disclosure will be described with reference to the accompanying drawings, wherein like numbers reference like elements.

FIG. 1 illustrates an outline of an overall configuration of a three-dimensional manufacturing apparatus to which a three-dimensional manufacturing method according to some embodiments can be applied.

FIG. 2 is a diagram for explaining an outline of a manufacturing method based on an LMD technology.

FIG. 3 is a diagram for explaining a case where one manufactured object is manufactured using a plurality of three-dimensional manufacturing apparatuses.

FIG. 4A illustrates an embodiment of a manufacturing nozzle.

FIG. 4B illustrates an embodiment of the manufacturing nozzle.

FIG. 4C illustrates an embodiment of the manufacturing nozzle.

FIG. 4D illustrates an embodiment of the manufacturing nozzle.

FIG. 4E illustrates an embodiment of the manufacturing nozzle.

FIG. 4F illustrates an embodiment of the manufacturing nozzle.

FIG. 4G illustrates an embodiment of the manufacturing nozzle.

FIG. 5A illustrates an example of another embodiment of a nozzle device.

FIG. 5B illustrates an example of another embodiment of the nozzle device.

FIG. 5C illustrates an example of another embodiment of the nozzle device.

FIG. 6 is a schematic diagram for explaining a device configuration for scanning a manufacturing nozzle and a cooling medium nozzle in the nozzle device illustrated in FIG. 5C.

FIG. 7A is a schematic diagram illustrating yet another embodiment of the nozzle device.

FIG. 7B is a schematic diagram illustrating yet another embodiment of the nozzle device.

FIG. 8A is a block diagram illustrating an overall configuration related to control of supply of a cooling medium in the nozzle device illustrated in

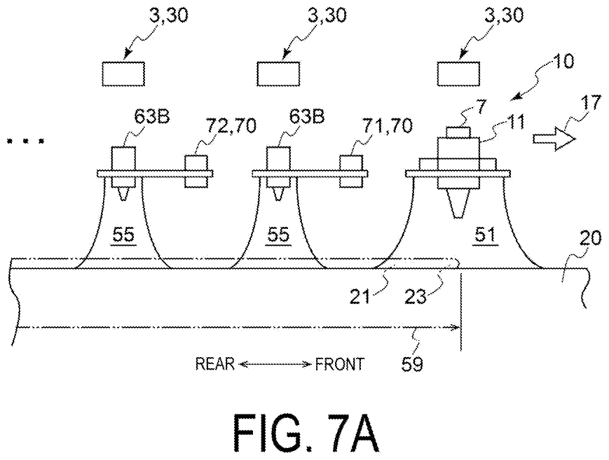

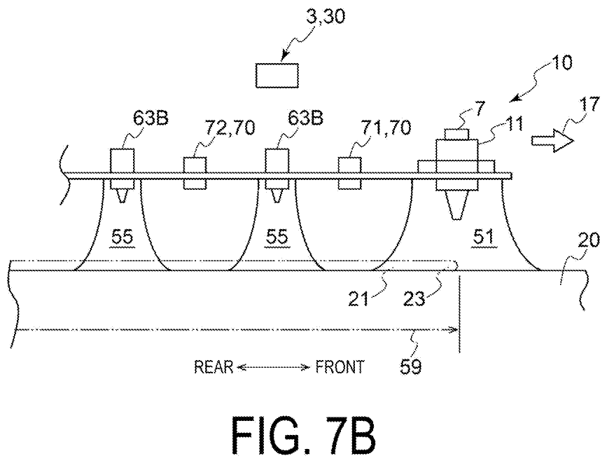

FIG. 7A.

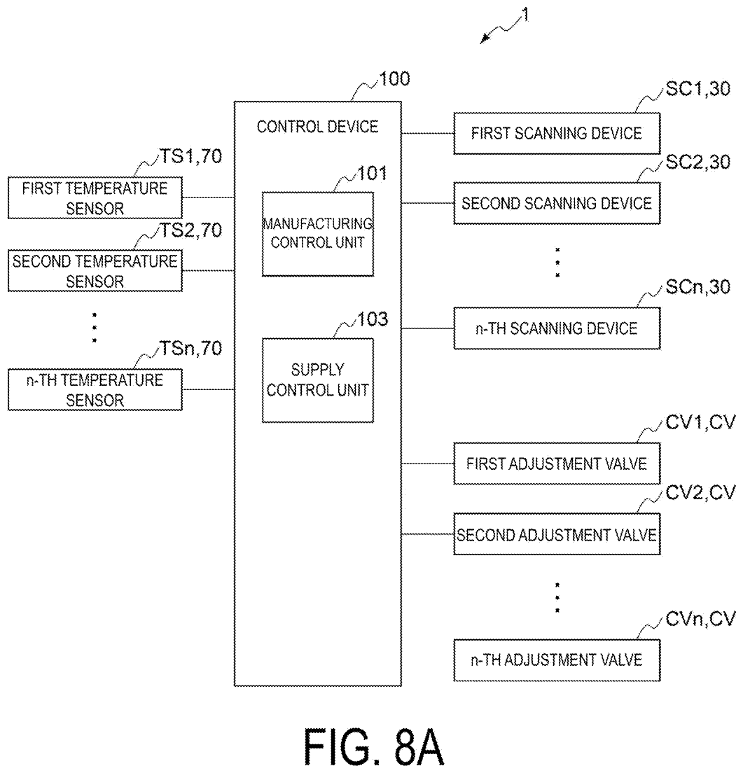

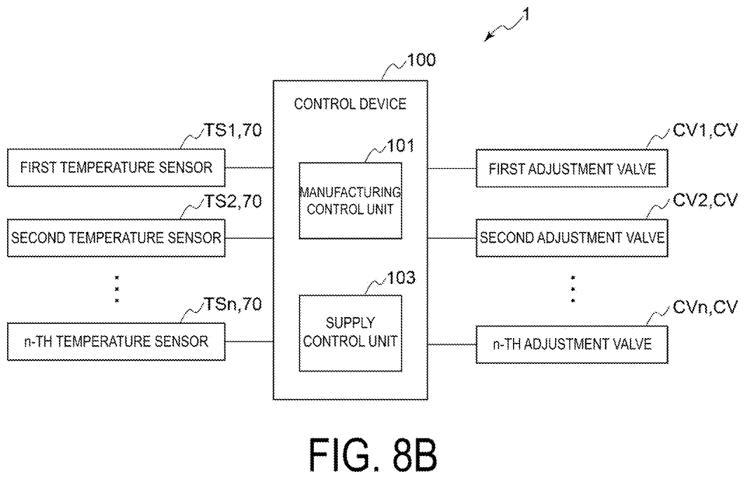

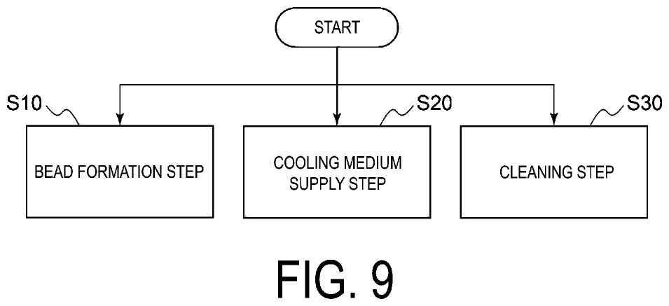

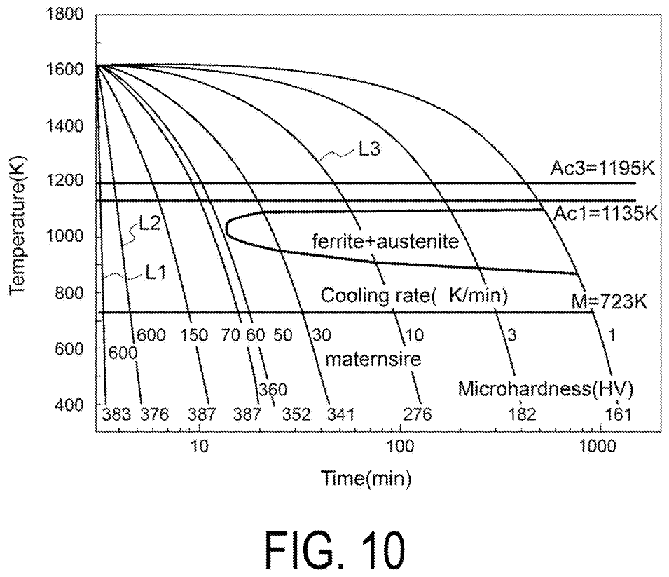

FIG. 8B is a block diagram illustrating an overall configuration related to control of supply of a cooling medium in the nozzle device illustrated in FIG. 7B.

FIG. 9 is a flow chart illustrating process procedures in a three-dimensional manufacturing method using a three-dimensional manufacturing apparatus according to some embodiments.

FIG. 10 illustrates a continuous cooling transformation curve (CCT curve) of steel.

### DESCRIPTION OF EMBODIMENTS

Some embodiments of the present disclosure will be described hereinafter with reference to the appended drawings. It is intended, however, that unless particularly specified, dimensions, materials, shapes, relative positions and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### (Overall Configuration of Three-Dimensional Manufacturing Apparatus 1)

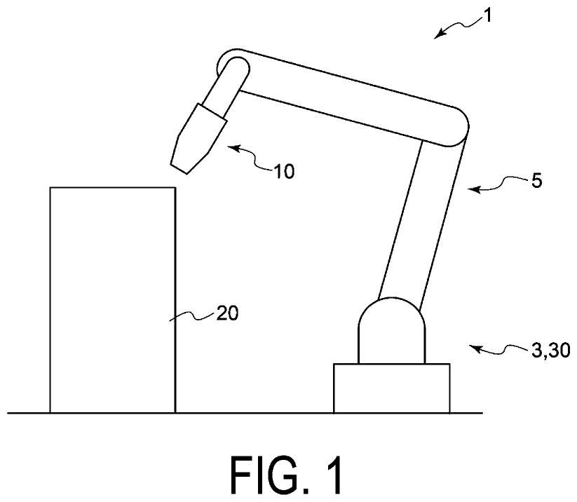

FIG. 1 illustrates an outline of an overall configuration of a three-dimensional manufacturing apparatus to which a three-dimensional manufacturing method according to some embodiments can be applied.

A three-dimensional manufacturing apparatus 1 according to some embodiments is an apparatus capable of performing additive manufacturing based on DED (Direct Energy Deposition). In the additive manufacturing based on DED, a metal powder or metal wire can be used as a material, and a solid manufactured object can be formed by melting the material with an arc or energy beam to form a bead and sequentially laminating the beads.

The three-dimensional manufacturing apparatus 1 according to some embodiments includes a nozzle device 10 for forming a bead and a nozzle scanning device 30 for scanning the nozzle device 10. The three-dimensional manufacturing apparatus 1 according to some embodiments includes an industrial robot 3 as the nozzle scanning device 30. That is, the three-dimensional manufacturing apparatus 1 according to some embodiments includes a robot arm 5 as a manipulator for the industrial robot 3 and the nozzle device 10 as an end effector.

In the following description, the three-dimensional manufacturing apparatus 1 according to some embodiments is a manufacturing apparatus, for example, based on a Laser Metal Deposition (LMD) technology as an example of the DED technology. Specifically, the three-dimensional manufacturing apparatus 1 according to some embodiments is an apparatus for manufacturing a three-dimensional additively-manufactured object 20 by emitting an energy beam such as a laser beam to a metal powder or the like, which is a material for a solid additively-manufactured object (three-dimensional additively-manufactured object), to melt the metal powder, and spraying, solidifying and laminating the molten metal powder.

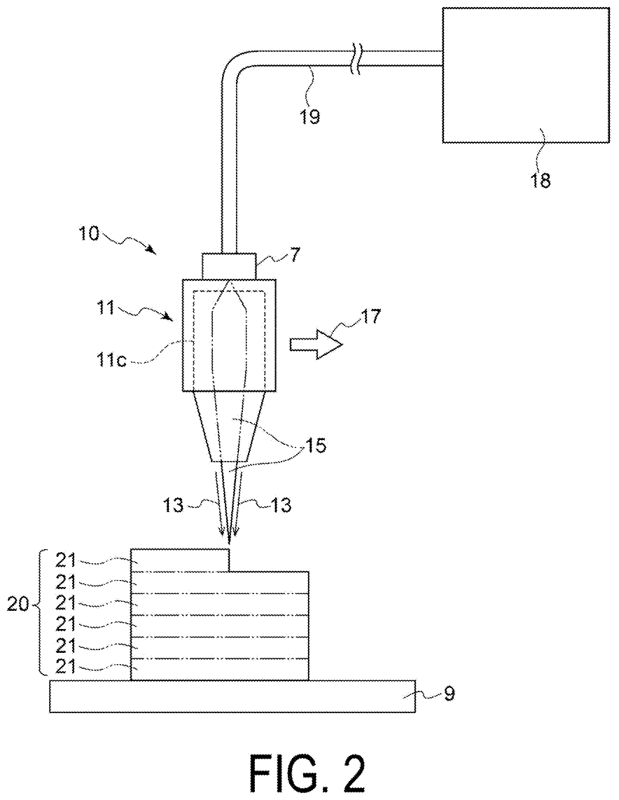

FIG. 2 is a diagram for explaining an outline of a manufacturing method based on the LMD technology. As illustrated in FIG. 2, the three-dimensional manufacturing apparatus 1 according to some embodiments includes the nozzle device 10 described above and an irradiation unit 7. The nozzle device 10 includes a manufacturing nozzle 11 for supplying a metal powder 13, which is a raw material for the three-dimensional additively-manufactured object 20. In the following description, the three-dimensional additively-manufactured object 20 is also referred to simply as manufactured object 20 or workpiece 20.

The irradiation unit 7 is a source of irradiation with an energy beam 15 such as a laser beam. The energy beam 15 is emitted from the irradiation unit 7 toward a manufacturing table 9 and the workpiece 20 being manufactured. When the energy beam 15 is, for example, a laser beam, a fiber cable 19 is fixed to the irradiation unit 7, and a laser oscillator 18 is connected via the fiber cable 19. In the irradiation unit 7, a laser beam is emitted from the fiber cable 19 toward the manufacturing table 9 and the workpiece 20 being manufactured. A lens or the like (not illustrated) for focusing the laser beam is stored in a casing 11c for the manufacturing nozzle 11.

The manufacturing nozzle 11 supplies the metal powder 13, which is a raw material for the three-dimensional additively-manufactured object 20, from a tip end of the manufacturing nozzle 11. The metal powder 13 supplied from the tip end of the manufacturing nozzle 11 to be scanned in a scanning direction 17 indicated by an arrow 17 is heated by the energy beam 15 to melt, and deposited as a bead 21 on the workpiece 20. In this way, the three-dimensional manufacturing apparatus 1 according to some embodiments can form a linear bead 21 that extends on the manufacturing table 9 and the workpiece 20 along the scanning direction for the manufacturing nozzle 11. The three-dimensional manufacturing apparatus 1 according to some embodiments can manufacture the three-dimensional additively-manufactured object 20 as a collection of the linear beads 21 through repeated scanning of the manufacturing nozzle 11.

Thus, in the three-dimensional manufacturing apparatus 1 according to some embodiments, the nozzle scanning device 30 includes the robot arm 5.

For example, in the case where the manufacturing nozzle 11 is scanned using a scanning device having a slide shaft that is movable in each direction of the X, Y, and Z axes, such as an NC device, the size of the workpiece 20 is restricted by the size of the scanning device. In addition, in the scanning device, the degree of freedom of the posture of the manufacturing nozzle 11 is restricted by the configuration of a drive system.

According to the three-dimensional manufacturing apparatus 1 according to some embodiments, the manufacturing nozzle 11 can be scanned using the robot arm 5, thereby making it easy to scan the manufacturing nozzle 11 in a wide range, as compared with the scanning device, even if the robot arm 5 is relatively compact. Therefore, the three-dimensional manufacturing apparatus 1 according to some embodiments can manufacture a larger manufactured object 20 than that manufactured using the above-described scanning device.

Additionally, according to the three-dimensional manufacturing apparatus 1 according to some embodiments, the degree of freedom of the posture of the manufacturing nozzle 11 is increased, thereby making it easy to manufacture even a manufactured object 20 having a complex shape.

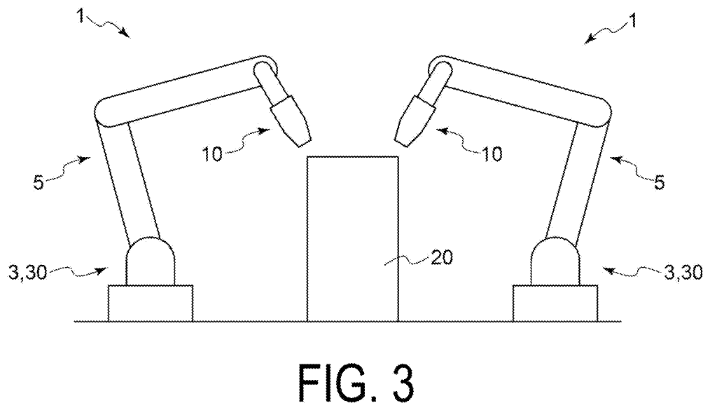

FIG. 3 is a diagram for explaining a case where one manufactured object 20 is manufactured using a plurality of three-dimensional manufacturing apparatuses 1. The example illustrated in FIG. 3 is an example of a case where one manufactured object is manufactured using two three-dimensional manufacturing apparatuses 1. One manufactured object 20 is manufactured using the plurality of three-dimensional manufacturing apparatuses 1 as illustrated in FIG. 3, thereby making it possible to manufacture the manufactured object 20 in a time shorter than that in the case where one manufactured object 20 is manufactured using one three-dimensional manufacturing apparatus 1. Also, the plurality of three-dimensional manufacturing apparatuses 1 are used as illustrated in FIG. 3, thereby making it possible to manufacture a manufactured object 20 larger than one manufactured object 20 when manufactured using one three-dimensional manufacturing apparatus 1.

### (Manufacturing Nozzle 11)

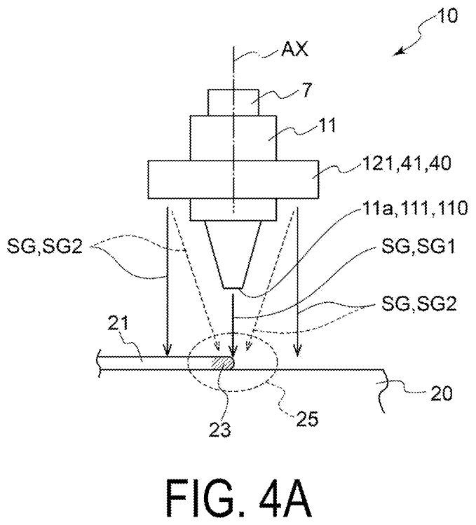

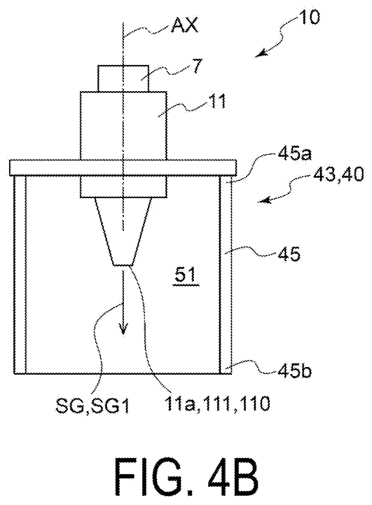

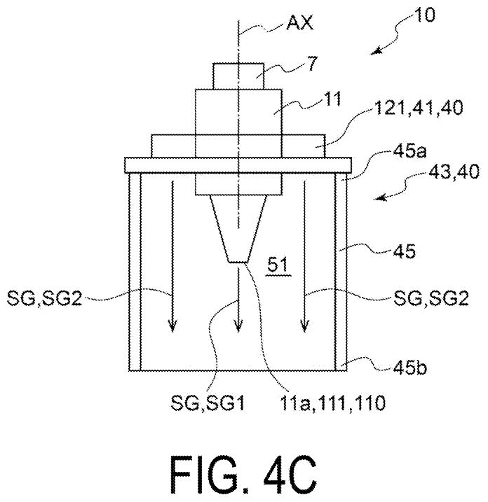

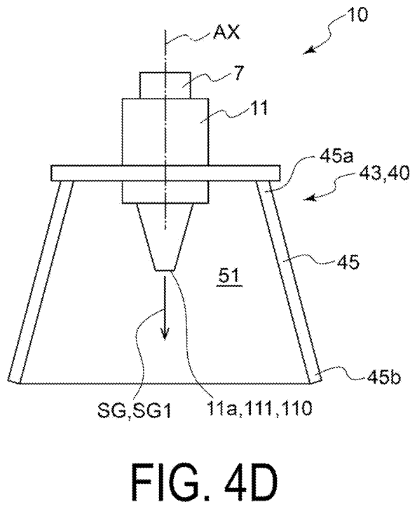

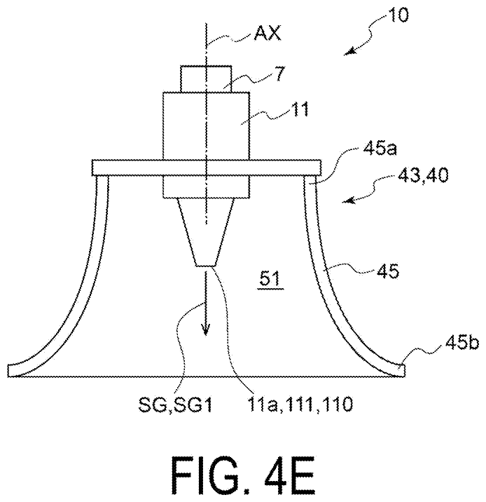

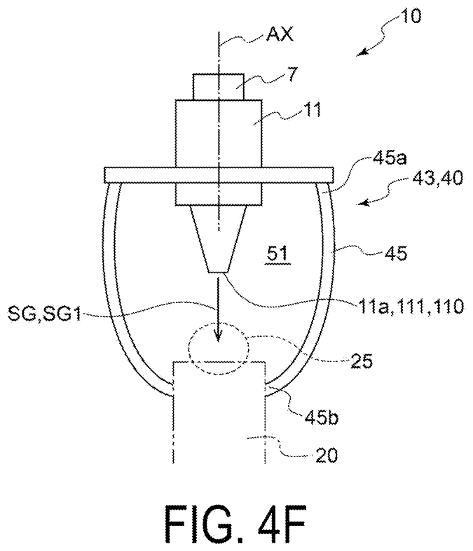

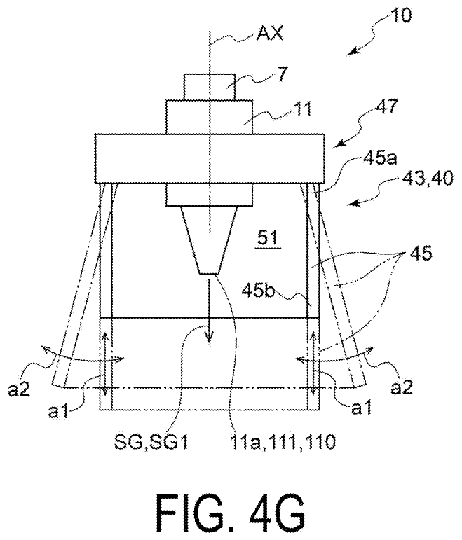

FIGS. 4A to 4G illustrate some embodiments of the manufacturing nozzle 11 in the nozzle device 10 used in the three-dimensional manufacturing apparatus 1 according to some embodiments. Note that the irradiation unit 7 is disposed on an axis AX in the manufacturing nozzle 11 as illustrated in FIGS. 4A to 4G and the manufacturing nozzle 11 as illustrated in other figures which will be described below, but that the irradiation unit 7 may emit the energy beam 15 from a position deviated from the axis AX of the manufacturing nozzle 11.

The manufacturing nozzle 11 as illustrated in FIGS. 4A to 4G is configured to be capable of injecting not only the metal powder 13, but also a shielding gas SG such as an inert gas, from the tip end of the manufacturing nozzle 11. In other words, a tip end part 11a of the manufacturing nozzle 11 as illustrated in FIGS. 4A to 4G is provided with a blowout unit 110 for the shielding gas SG. The blowout unit 110 provided at the tip end part 11a of the manufacturing nozzle 11 is also referred to as first blowout unit 111. The shielding gas SG that is injected from the first blowout unit 111 is also referred to as first shielding gas SG1.

From the manufacturing nozzle 11 as illustrated in FIGS. 4A to 4G, the first shielding gas SG1 can be blown out from the first blowout unit 111, and thus a forming region 25 for the bead 21, which includes a molten pool 23 of the bead 21 as illustrated in FIG. 4A, can be brought into a shielding gas atmosphere. As a result, even a metal easily oxidizable at a high temperature can be suppressed from being oxidized during formation of the bead 21.

Note that, in FIG. 4A, a region of the bead 21 corresponding to the molten pool 23 is hatched.

As described above, when the industrial robot 3 is used as the nozzle scanning device 30, it is conceivable that the three-dimensional manufacturing apparatus 1 and the workpiece 20 are surrounded, for example, by a shielding box, and that the shielding box is filled with an inert gas, thereby preventing oxidation during formation of the beads 21. However, if a shielding box is provided, the size of the workpiece 20 will be restricted by the size of the shielding box. In addition, because the volume within the shielding box increases, the time required to fill the shielding box with the inert gas and the amount of the inert gas required will increase.

In the case where no shielding box is provided, the bead 21 will easily be oxidized in a region around the forming region 25 for the bead 21 if the shielding gas SG diffuses to surroundings.

So, a second blowout unit 121, which is the blowout unit 110 capable of blowing out the shielding gas SG, is provided in addition to the first blowout unit 111, as is the case of the manufacturing nozzle 11 illustrated in FIG. 4A, thereby making it possible to enlarge the region that can be brought into the shielding gas atmosphere and to suppress oxidation of the bead 21.

For example, in the example illustrated in FIG. 4A, the second blowout unit 121 is provided on a side of the manufacturing nozzle 11 having a columnar shape. In the example illustrated in FIG. 4A, the second blowout unit 121 is configured to be capable of blowing out the shielding gas SG toward the workpiece 20 along the axis AX of the manufacturing nozzle 11 having a columnar shape. The second blowout unit 121 is preferably configured to blow out the shielding gas SG annularly so as to surround the axis AX. For example, the second blowout unit 121 may be provided with a blowout port (not illustrated) for the shielding gas SG which is formed in an annular shape so as to surround the axis AX. In addition, for example, the second blowout unit 121 may be provided with a plurality of blowout ports (not illustrated) for the shielding gas SG which are formed at intervals along the circumferential direction centered on the axis AX. The shielding gas SG injected from the second blowout unit 121 is also referred to as second shielding gas SG2.

Note that, in the following description of the nozzle device 10, the radial direction centered on the axis AX is also referred to simply as radial direction, and the circumferential direction centered on the axis AX is also referred to simply as circumferential direction.

The second blowout unit 121 may be configured to blow out the second shielding gas SG2 toward the molten pool 23, for example, as indicated by dashed arrows.

Note that, in the case where the second shielding gas SG2 is blown out annularly so as to surround the axis AX, for example, as indicated by solid arrows, the second shielding gas SG2 forms an airflow curtain that suppresses diffusion of the first shielding gas SG1 by a flow of gas. In this case, the second blowout unit 121 will constitute an airflow curtain formation unit 41. The airflow curtain formation unit 41 serves also as a shielding mechanism 40 for suppressing diffusion of the first shielding gas SG1.

Therefore, according to the manufacturing nozzle 11 illustrated in FIG. 4A, diffusion of the shielding gas SG can be suppressed by the airflow curtain. Thus, even if the shape of the workpiece 20 is complex, the atmosphere of the region forming the bead 21 is easily maintained to be a shielding gas SG atmosphere.

For example, in the manufacturing nozzle 11 illustrated in FIG. 4B, a cover member 43 is provided as the shielding mechanism 40. Note that, in FIGS. 4B and 4C to 4G which will be described below, a cross section along the axis AX is illustrated for a portion of a brush 45 which will be described below.

The cover member 43 illustrated in FIG. 4B is a member having a cylindrical shape centered on the axis AX, for example, and configured to cover at least an area from the tip end part 11a of the manufacturing nozzle 11 to a surface of the workpiece 20. The cover member 43 may be, for example, a brush-like member in which flexible fibers that extend along the axis AX are bundled. In other words, the cover member 43 illustrated in FIG. 4B may be an aggregate of fibers (brush) 45 bundled into a cylindrical shape.

The fibers used in the cover member 43 are preferably made of a material that is not susceptible to heat by the bead 21, and may be, for example, glass fibers or metallic fine wires. When metallic fine wires are used as the cover member 43, the fine wires preferably have the same composition as the composition of the metal powder 13 that is the raw material for the manufactured object 20. As a result, even if the fine wires are mixed into the bead 21, the influence thereof on the manufactured object 20 can be suppressed.

Note that, as long as the influence of the metallic fine wires on the manufactured object 20 can be ignored even if the metallic fine wires are mixed into the bead 21, fine wires made of a metal relatively greatly different in composition from the metal powder 13 may be used in the cover member 43.

According to the manufacturing nozzle 11 illustrated in FIG. 4B, the first shielding gas SG1 that is injected from the first blowout unit 111 is blown out into a cylindrical space 51 formed by the cover member 43. The first shielding gas SG1 blown out into the space 51 is suppressed from diffusing out of the space 51 by the cover member 43 surrounding the space 51. Also, according to the manufacturing nozzle 11 illustrated in FIG. 4B, the cover member 43 has flexibility, and thus the shape of the brush 45 easily follows the shape of the workpiece 20 even if the shape of the workpiece 20 is complex, and the atmosphere of the space 51 is easily maintained to be the shielding gas SG atmosphere. As a result, the bead 21 can be formed under the shielding gas SG atmosphere.

The second blowout unit 121 provided in the manufacturing nozzle 11 illustrated in FIG. 4A and the cover member 43 provided in the manufacturing nozzle 11 illustrated in FIG. 4B may be provided, as is the case of the manufacturing nozzle 11 illustrated in FIG. 4C, for example.

FIGS. 4D to 4G illustrate examples of variations of the cover member 43.

As is the case of the manufacturing nozzle 11 illustrated in FIG. 4D, the cover member 43 may be formed such that a tip end 45b side of the brush 45 expands radially about the axis AX as compared with a base end 45a side of the brush 45, and that the cover member 43 has a conical shape. As a result, the surface area of the workpiece 20 which can be brought into the shielding gas SG atmosphere can be enlarged.

Note that the cover member 43 may be formed such that its diameter gradually expands from the base end 45a side of the brush 45 toward the tip end 45b side thereof, and that the cross-section along the axis AX direction has a concave curved surface that is recessed radially inward, as is the case of the manufacturing nozzle 11 illustrated in FIG. 4E. As a result, the surface area of the workpiece 20 which can be brought into the shielding gas SG atmosphere can further be enlarged.

The cover member 43 may be formed such that its diameter gradually reduces from the base end 45a side of the brush 45 toward the tip end 45b side thereof, and that the cross-section along the axis AX direction has a convex curved surface that protrudes radially outward, as is the case of the manufacturing nozzle 11 illustrated in FIG. 4F. Briefly, as is the case of the manufacturing nozzle 11 illustrated in FIG. 4F, the cover member 43 may be formed such that the tip end 45b of the brush 45 faces radially inward about the axis AX. As a result, even if the workpiece 20 protrudes toward the manufacturing nozzle 11 along the axis AX direction and has a site having a relatively small lateral dimension as illustrated, for example, the forming region 25 for the bead 21 can be brought into the shielding gas atmosphere.

For example, as is the case of the manufacturing nozzle 11 illustrated in FIG. 4G, a brush shape changing unit 47 for changing the shape of the brush 45 may be provided. The brush shape changing unit 47 illustrated in FIG. 4G is preferably configured to be capable of changing the length of the brush 45, as indicated by an arrow a1. Also, the brush shape changing unit 47 illustrated in FIG. 4G is preferably configured to be capable of changing an expanding manner of the tip end 45b of the brush 45 in the radial direction, as indicated by an arrow a2.

As illustrated in FIGS. 4B to 4G, in some embodiments, the shielding mechanism 40 includes the cover member 43 that is disposed as to surround the blowout unit 110 from its surroundings when viewed along the direction of irradiation with the energy beam 15 emitted from the manufacturing nozzle 11, i.e., along the axis AX.

As a result, the diffusion of the shielding gas SG is suppressed by the cover member 43, so the atmosphere of the region for forming the bead 21 (forming region 25) is easily maintained to be the shielding gas atmosphere.

Note that in the manufacturing nozzle 11 as illustrated in FIGS. 4B to 4G, the first blowout unit 111 is present in the space 51 covered by the cover member 43.

As illustrated in FIGS. 4A and 4C, in some embodiments, the blowout unit 110 includes the first blowout unit 111 configured to blow out the shielding gas SG from the tip end of the manufacturing nozzle 11 (tip end part 11a) and the second blowout unit 121 disposed on the side of the manufacturing nozzle 11 and configured to blow out the shielding gas SG.

As a result, the shielding gas SG is blown out from the tip end of the manufacturing nozzle 11 and the side of the manufacturing nozzle 11, thereby making it easy to maintain the atmosphere of the region for forming the bead 21 (forming region 25) to be the shielding gas atmosphere.

Thus, in some embodiments, the shielding mechanism 40 forms a retention region for the shielding gas SG.

### (Cooling Medium Nozzle 60)

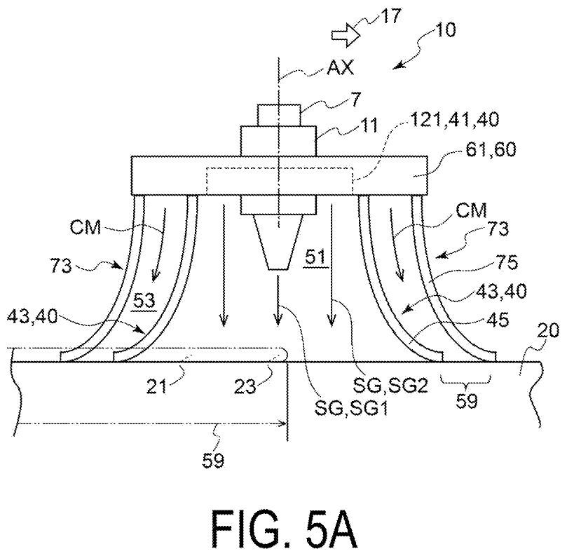

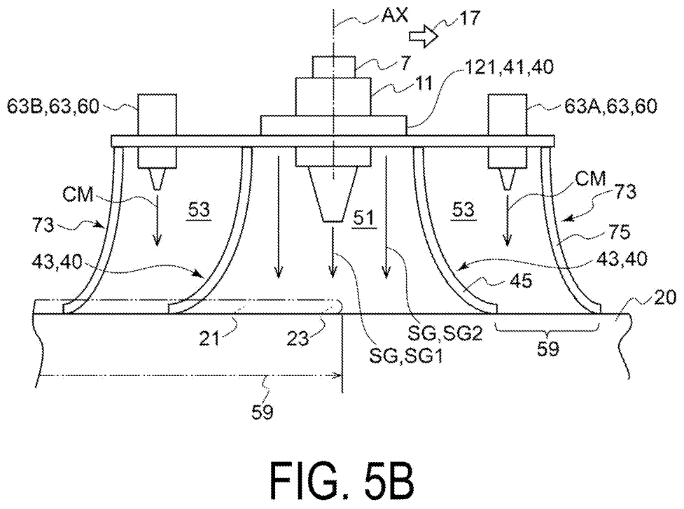

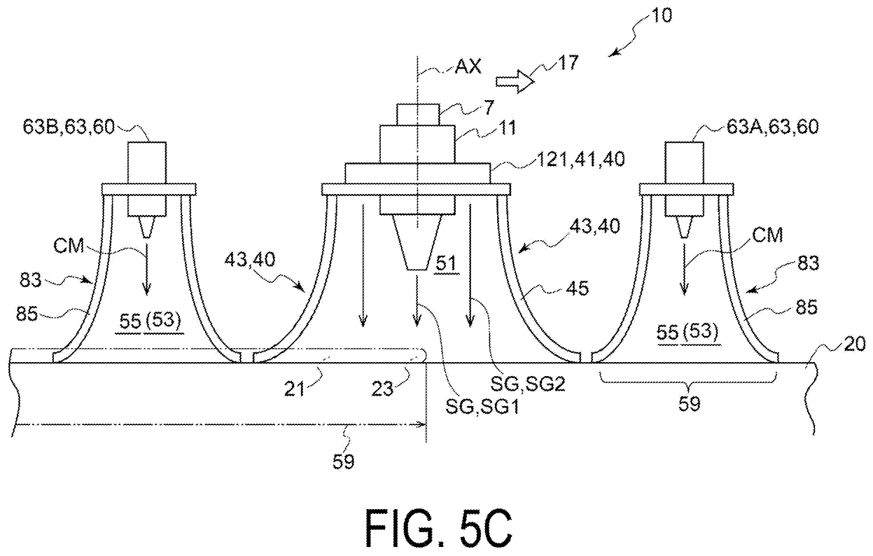

FIGS. 5A to 5C illustrate examples of other embodiments of the nozzle device 10 used in the three-dimensional manufacturing apparatus 1 according to some embodiments.

In the three-dimensional manufacturing apparatus 1 according to some embodiments, the nozzle device 10 may include a cooling medium nozzle 60, as illustrated in FIGS. 5A to 5C. The cooling medium nozzles 60 according to some embodiments are nozzles for spraying a cooling medium CM toward a cooling target region 59, as will be described later, as a region, which includes the bead 21, of the workpiece 20, so that the cooling target region 59 is cooled locally. Hereinafter, the cooling medium nozzles 60 according to some embodiments will be described in detail.

The nozzle device 10 as illustrated in FIGS. 5A to 5C, for example, may include the manufacturing nozzle 11 illustrated in FIG. 4A and any of the cover members 43 illustrated in FIGS. 4B to 4G, for example. Note that the nozzle device 10 as illustrated in FIGS. 5A to 5C includes the cover member 43 illustrated in FIG. 4E.

In the nozzle device 10 illustrated in FIG. 5A, the manufacturing nozzle 11 and the cooling medium nozzle 60 are integrated. In the nozzle device 10 illustrated in FIG. 5B, the manufacturing nozzle 11 and two cooling medium nozzles 60 are integrated. In the nozzle device 10 illustrated in FIG. 5C, the manufacturing nozzle 11 and two cooling medium nozzles 60 are each independently provided.

Among the cooling medium nozzles 60 of some embodiments, an annular nozzle 61 in the nozzle device 10 illustrated in FIG. 5A is provided on a side of the manufacturing nozzle 11 having a columnar shape, and configured to blow out the cooling medium CM toward a surface of the workpiece 20 in a region 53 radially outward of the cover member 43. In the annular nozzle 61 illustrated in FIG. 5A, a blowout port (not illustrated) for the cooling medium CM may be formed in an annular shape so as to surround the axis AX, for example. Additionally, in the annular nozzle 61 illustrated in FIG. 5A, a plurality of blowout ports (not illustrated) for the cooling medium CM may be formed at intervals along the circumferential direction centered on the axis AX, for example.

Among the cooling medium nozzles 60 of some embodiments, the cooling medium nozzle 63 in the nozzle device 10 as illustrated in FIGS. 5B and 5C is disposed in two locations on front and rear sides in the scanning direction 17 relative to the manufacturing nozzle 11. The cooling medium nozzle 63 disposed on the front side in the scanning direction 17 relative to the manufacturing nozzle 11 is also referred to as front nozzle 63A, and the cooling medium nozzle 63 disposed on the rear side in the scanning direction 17 relative to the manufacturing nozzle 11 is also referred to as rear nozzle 63B. The front nozzle 63A and the rear nozzle 63B are configured to blow out the cooling medium CM toward the surface of the workpiece 20 in the region 53 radially outward of the cover member 43.

The nozzle device 10 as illustrated in FIGS. 5A and 5B is provided with a cover member 73 for effectively spraying the cooling medium CM toward the workpiece 20 while suppressing diffusion of the cooling medium CM.

For convenience of explanation, in the following description, the cover member 43 as the shielding mechanism 40 of the shielding gas SG described above is also referred to as first cover member 43, and the cover member 73 for suppressing diffusion of the cooling medium CM is also referred to as second cover member 73.

The second cover member 73 as illustrated in FIGS. 5A and 5B is disposed radially outward of the first cover member 43 so as to be spaced radially from the first cover member 43, and configured to circumferentially cover the first cover member 43. The second cover member 73 as illustrated in FIGS. 5A and 5B is a member configured to cover an area from the cooling medium nozzle 60 to the surface of the workpiece 20. Similarly to the first cover member 43, the second cover member 73 may be a brush-like member in which flexible fibers are bundled. That is, the second cover member 73 as illustrated in FIGS. 5A and 5B may be an aggregate of fibers (brush) 75 bundled into a wide-based shape. The fibers used in the second cover member 73 are preferably made of the same material as that for the first cover member 43.

In the nozzle device 10 as illustrated in FIGS. 5A and 5B, the cooling medium CM can be blown out from the annular nozzle 61 or the cooling medium nozzle 63 toward the concentric circular region 53 surrounded by the first cover member 43 and the second cover member 73. As a result, the surface of the workpiece 20 that contacts the concentric circular region 53 surrounded by the first cover member 43 and the second cover member 73 and the bead 21 present in the region 53 can be locally cooled by the cooling medium CM.

Thus, the time to wait for the temperature of the workpiece 20 to decrease during manufacturing can be shortened, and the production efficiency is improved.

Note that, in the nozzle device 10 as illustrated in FIGS. 5A and 5B, the annular nozzle 61 or the cooling medium nozzle 63 can supply the cooling medium CM to the region 53 opposite to the space 51 with the cover member 43 interposed therebetween.

In the nozzle device 10 illustrated in FIG. 5C, the cooling medium nozzle 63 preferably includes a cover member 83 having a configuration similar to that of any of the first cover members 43 illustrated in FIGS. 4B to 4G, in order to effectively blow out the cooling medium CM toward the workpiece 20 while suppressing diffusion of the cooling medium CM. Note that, in the example illustrated in FIG. 5C, the cooling medium nozzle 63 includes a cover member 83 having a configuration similar to that of the first cover member 43 illustrated in FIG. 4E. For convenience of explanation, in the following description, the cover member 83 included in the cooling medium nozzle 63 illustrated in FIG. 5C is also referred to as third cover member 83. The third cover member 83 may be an aggregate of fibers (brush) 85 bundled in the same manner as in the first cover member 43.

In the nozzle device 10 illustrated in FIG. 5C, the cooling medium CM can be blown out from the cooling medium nozzles 63 toward the region 55 surrounded by the third cover member 83. As a result, the surface of the workpiece 20 that contacts the region 55 surrounded by the third cover member 83 and the bead 21 present in the region 55 can be locally cooled by the cooling medium CM.

Thus, the time to wait for the temperature of the workpiece 20 to decrease during manufacturing can be shortened, and the production efficiency is improved.

Note that, in some embodiments, the region desired to be cooled by the cooling medium CM is referred to as cooling target region 59.

Also note that, in some embodiments, the cooling medium CM is sprayed from the cooling medium nozzle 60 toward the surface of the workpiece 20, thereby making it possible to remove and clean a deposit and the like on the surfaces of the workpiece 20 and the bead 21.

Air, an inert gas, a liquid such as water, pellet-shaped or powdery ice, liquid nitrogen, pellet-shaped or powdery dry ice, and the like can be used as the cooling medium CM.

For example, if pellet-shaped or powdery dry ice is used as the cooling medium CM, the dry ice after being sprayed onto the workpiece 20 sublimates quickly after cooling and cleaning of the workpiece 20, so it is not necessary to worry about the risk that the dry ice may remain as a foreign substance on and around the workpiece 20. In addition, if the dry ice is pellet-shaped or powdery, it is easy to supply the dry ice from the cooling medium nozzles 60 according to some embodiments.

In the nozzle device 10 illustrated in FIG. 5A, the cooling medium CM that is injected onto the surface of the workpiece 20 positioned on the front side in the scanning direction 17 relative to the manufacturing nozzle 11 cools the workpiece 20, and cleans the surface of the workpiece 20 immediately before the formation of the bead 21. In the nozzle device 10 illustrated in FIG. 5A, the cooling medium CM that is injected onto the surface of the workpiece 20 positioned on the rear side in the scanning direction 17 relative to the manufacturing nozzle 11, cools the bead 21 formed immediately before and the workpiece 20 and cleans the surfaces of the bead 21 and the workpiece 20.

In the nozzle device 10 as illustrated in FIGS. 5B and 5C, the cooling mediums CM that are injected from the front nozzle 63A cool the workpiece 20 and clean the surface of the workpiece 20. In the nozzle device 10 as illustrated in FIGS. 5B and 5C, the cooling mediums CM that are injected from the rear nozzle 63B cool the bead 21 and the workpiece 20 and clean the surfaces of the bead 21 and the workpiece 20.

As described above, in the nozzle device 10 as illustrated in FIGS. 5A and 5B, the manufacturing nozzle 11 and the cooling medium nozzle 60 are integrated. Thus, the nozzle device 10 as illustrated in FIGS. 5A and 5B can be scanned by the single industrial robot 3 (nozzle scanning device 30) as illustrated in FIG. 1, for example.

In other words, the single nozzle scanning device 30 that scans the nozzle device 10 as illustrated in FIGS. 5A and 5B can scan the cooling medium nozzle 60, following scanning of the manufacturing nozzle 11. In this case, the nozzle scanning device 30 can integrally scan the manufacturing nozzle 11 and the cooling medium nozzle 60.

The cooling medium nozzle 60 is scanned, following the scanning of the manufacturing nozzle 11, whereby localized cooling of the cooling target region 59, which includes the bead 21, of the workpiece 20 can efficiently be performed. Thus, the amount of the cooling medium CM to be consumed can be suppressed.

In addition, since the manufacturing nozzle 11 and the cooling medium nozzle 60 are scanned integrally, the complication of the device configuration of the nozzle scanning device 30 and the contents of control of the nozzle scanning device 30 can be suppressed.

Note that, in the above description, in the nozzle device 10 as illustrated in FIGS. 5B and 5C, the cooling medium nozzle 63 is disposed in two locations on the front and rear sides of the scanning direction 17 relative to the manufacturing nozzle 11. However, in the nozzle device 10 as illustrated in FIGS. 5B and 5C, the cooling medium nozzle 63 may be disposed only on one of the front and rear sides of the scanning direction 17 relative to the manufacturing nozzle 11.

Also, in the annular nozzle 61 illustrated in FIG. 5A, the blowout port (not illustrated) for the cooling medium CM may be formed, for example, in an annular ring shape so as to surround the axis AX, but may be formed in a shape such that at least a part of the annular ring shape is missing.

In the annular nozzle 61 illustrated in FIG. 5A, a plurality of blowout ports (not illustrated) for the cooling medium CM may be formed, for example, at intervals along the circumferential direction centered on the axis AX, but may not necessarily be formed throughout the entire circumference.

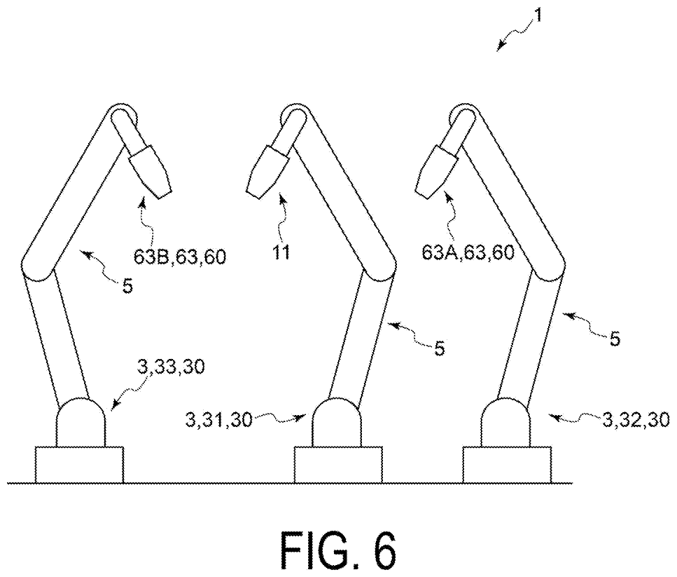

FIG. 6 is a schematic diagram for explaining a device configuration for scanning the manufacturing nozzle 11 and the cooling medium nozzles 60 in the nozzle device 10 illustrated in FIG. 5C.

In the nozzle device 10 illustrated in FIG. 5C, the manufacturing nozzle 11 and the cooling medium nozzles 60 are each independently provided, as described above. Thus, the nozzle device 10 illustrated in FIG. 5C can be scanned by three industrial robots 3 (nozzle scanning devices 30) as illustrated in FIG. 6, for example. In other words, the manufacturing nozzle 11 illustrated in FIG. 5C can be scanned by the manufacturing nozzle scanning device 31 illustrated in FIG. 6; the front nozzle 63A illustrated in FIG. 5C can be scanned by the front nozzle scanning device 32; and the rear nozzle 63B illustrated in FIG. 5C can be scanned by the rear nozzle scanning device 33.

The scanning of each of the nozzles by the manufacturing nozzle scanning device 31, the front nozzle scanning device 32, and the rear nozzle scanning device 33 is appropriately controlled, thereby making it possible to scan the front nozzle 63A and the rear nozzle 63B, following the scanning of the manufacturing nozzle 11.

Note that the scanning of each of the nozzles by the manufacturing nozzle scanning device 31, the front nozzle scanning device 32, and the rear nozzle scanning device 33 is appropriately controlled, thereby making it possible to scan the manufacturing nozzle 11, the front nozzle 63A and the rear nozzle 63B individually.

As a result, even if the scanning rates required for the manufacturing nozzle 11, the front nozzle 63A, and the rear nozzle 63B are different, the nozzles can be scanned at scanning rates appropriate for the respective nozzles.

### (Control of Supply of Cooling Medium CM)

FIGS. 7A and 7B are schematic diagrams illustrating yet another embodiment of the nozzle device 10 used in the three-dimensional manufacturing apparatuses 1 according to some embodiments.

The nozzle device 10 as illustrated in FIGS. 7A and 7B includes the manufacturing nozzle 11 and the shielding mechanism 40, for example, as illustrated in FIG. 5C, and the rear nozzle 63B, for example, as illustrated in FIG. 5C. In the nozzle device 10 as illustrated in FIGS. 7A and 7B, a plurality of the rear nozzles 63B are disposed along the scanning direction on the rear side in the scanning direction 17 relative to the manufacturing nozzle 11.

Note that, in the following description, the front side in the scanning direction 17 is also referred to simply as front side, and the rear side in the scanning direction 17 is also referred to simply as rear side.

In the nozzle device 10 as illustrated in FIGS. 7A and 7B, a temperature sensor 70 for detecting the temperature of the bead 21 is disposed on a front side of each of the rear nozzles 63B.

For convenience of explanation, the rear nozzles 63B will also be referred to as first rear nozzle N1, second rear nozzle N2, . . . and n-th rear nozzle Nn (not illustrated) in the order from the front side to the rear side. The temperature sensor 70 on the front side of the first rear nozzle N1 is also referred to as first temperature sensor TS1, and the temperature sensor 70 on the front side of the second rear nozzle N2 is also referred to as second temperature sensor TS2. In other words, the temperature sensor 70 disposed immediately before the n-th (n is a natural number) rear nozzle from the front side is also referred to as n-th temperature sensor TSn. In the following description, where the alphabet “n” is used for representing an arbitrary number, n shall represent a natural number.

In the nozzle device 10 illustrated in FIG. 7A, the manufacturing nozzle 11 and the respective rear nozzles 63B are each independently provided. The nozzle device 10 illustrated in FIG. 7A is configured so that the manufacturing nozzle 11 and the respective rear nozzles 63B can each be independently scanned by different nozzle scanning devices 30.

The nozzle scanning device 30 that scans the manufacturing nozzle 11 is also referred to as the manufacturing nozzle scanning device 31 as described above. The nozzle scanning device 30 that scans the first rear nozzle N1 is also referred to as first scanning device SC1. The nozzle scanning device 30 that scans the second rear nozzle N2 is also referred to as second scanning device SC2. In other words, the nozzle scanning device 30 that scans the n-th rear nozzle Nn is also referred to as n-th scanning device SCn.

In the nozzle device 10 illustrated in FIG. 7B, the manufacturing nozzle 11 and the respective rear nozzles 63B are integrated. The nozzle device 10 illustrated in FIG. 7B is configured so that the integrated manufacturing nozzle 11 and respective rear nozzles 63B can be scanned by the single nozzle scanning device 30.

FIG. 8A is a block diagram illustrating an overall configuration related to control of supply of the cooling medium CM in the nozzle device 10 illustrated in FIG. 7A, and FIG. 8B is a block diagram illustrating an overall configuration related to control of the supply of the cooling medium CM in the nozzle device 10 illustrated in FIG. 7B. Note that, in the block diagrams illustrated in FIG. 8A and FIG. 8B, the configuration related to the control of the supply of the cooling medium CM is mainly illustrated, but a configuration not related to the control of the supply of the cooling medium CM is omitted.

As illustrated in FIGS. 8A and 8B, the three-dimensional manufacturing apparatus 1 according to some embodiments has a control device 100 for controlling units of the three-dimensional manufacturing apparatus 1. The control device 100 according to some embodiments includes a manufacturing control unit 101 and a supply control unit 103 as functional blocks of the control device 100. Note that the manufacturing control unit 101 and the supply control unit 103 may each be configured by dedicated hardware, not as function blocks.

The manufacturing control part 101 as illustrated in FIGS. 8A and 8B controls items involved in formation of the bead 21, such as the position of and the scanning rate for the manufacturing nozzle 11, the output of the energy beam 15, and the supplying rate of the metal powder 13.

The supply control unit 103 illustrated in FIGS. 8A and 8B controls an amount of the cooling medium CM to be sprayed per unit time, and thus controls an amount of the cooling medium CM to be supplied per unit surface area of the workpiece 20. Specifically, the supply control unit 103 as illustrated in FIGS. 8A and 8B controls the degree of opening of an adjustment valve CV in order to control the amount of the cooling medium CM to be sprayed from each of the rear nozzles 63B, and thus controls the amount of the cooling medium CM to be sprayed from each of the rear nozzles 63B.

The adjustment valve CV for controlling the amount of the cooling medium CM to be sprayed from the first rear nozzle N1 is also referred to as first adjustment valve CV1. The adjustment valve CV for controlling the amount of the cooling medium CM to be sprayed from the second rear nozzle N2 is also referred to as second adjustment valve CV2. In other words, the adjustment valve CV for controlling the amount of the cooling medium CM to be sprayed from the n-th rear nozzle Nn is also referred to as n-th adjustment valve CVn.

The supply control unit 103 illustrated in FIG. 8A can control the scanning rate of each of the nozzle scanning devices 30 from the first scanning device SC1 to the n-th scanning device SCn.

Information on the detected temperature detected by each of the temperature sensors 70 is input to the supply control unit 103 as illustrated in FIGS. 8A and 8B.

In the control device 100 configured in this manner, the supply control unit 103 controls the amount of the cooling medium CM to be sprayed from each of the rear nozzles 63B, for example.

The supply control unit 103 acquires, from the manufacturing control unit 101, information on the scanning rate for the manufacturing nozzle 11 when additive manufacturing is performed, and a target value of the temperature (target temperature Tt) of the workpiece 20 or bead 21 after cooling by the cooling medium CM.

Once additive manufacturing is started, the supply control unit 103 acquires information on the detected temperature detected by each of the temperature sensors 70. Then, the supply control unit 103 calculates the amount of the cooling medium CM to be sprayed from each of the rear nozzles 63B based on the detected temperature detected by each of the temperature sensors 70 and the target temperature Tt described above. The supply control unit 103 controls the degree of opening of each of the adjustment valves CV so that the calculated amount of the cooling medium CM to be sprayed is attained.

Note that the cooling capacity of the cooling medium CM depends on an amount Q/S (g/cm²) of the cooling medium CM to be supplied per unit surface area of the workpiece 20. Therefore, an amount Q/t (g/sec) of the cooling medium CM to be sprayed per unit time from the rear nozzle 63B is changed, thereby making it possible to change the amount Q/s (g/cm²) of the cooling medium CM to be supplied per unit surface area of the workpiece 20. In addition, a scanning rate Vs (m/sec) of the rear nozzle 63B is changed, thereby making it possible to change the amount Q/s (g/cm²) of the cooling medium CM to be supplied per unit surface area of the workpiece 20.

In the supply control unit 103 illustrated in FIG. 8A, the scanning rate Vs of each of the rear nozzles 63B can be changed so that the calculated amount of the cooling medium CM to be sprayed (more specifically, the amount Q/s (g/cm²) of the cooling medium CM to be supplied per unit surface area of the workpiece 20) is attained.

Note that, in a case where the supply control unit 103 determines that the temperature detected by the m temperature sensor TSm (for example, m is a natural number equal to or less than n) is the target temperature Tt or lower, the supply control unit 103 sets the degree of opening from the m adjustment valve CVm to the n-th adjustment valve CVn to zero. As a result, the cooling medium CM is not blown out from the m-th rear nozzle Nm or the rear nozzle 63B disposed on a rear side of the m-th rear nozzle Nm, and thus it is possible to suppress the temperature of the cooling target region 59 from being unnecessarily reduced.

As such, the three-dimensional manufacturing apparatus 1 according to some embodiments includes at least the temperature sensor 70 that detects the temperature of the cooling target region 59. Further, the three-dimensional manufacturing apparatus 1 according to some embodiments includes the control device 100 (supply control unit 103) for controlling at least one of the scanning rate of the cooling medium nozzle 60 or the amount of the cooling medium to be sprayed per unit time, based on the detection result from the temperature sensor 70.

According to the three-dimensional manufacturing apparatus 1 according to some embodiments, at least one of the scanning rate of the cooling medium nozzle 60 or the amount of the cooling medium to be sprayed per unit time can be controlled based on the detection result from the temperature sensor 70. So, the cooling medium CM can be sprayed in a proper amount, the cooling medium CM can efficiently be used, and the cost associated with the cooling medium CM can be suppressed.

### (Flow Chart)

FIG. 9 is a flow chart illustrating process procedures in a three-dimensional manufacturing method using the three-dimensional manufacturing apparatus 1 according to some embodiments.

As illustrated in FIG. 9, a three-dimensional manufacturing method using the three-dimensional manufacturing apparatus 1 according to some embodiments includes a bead formation step S10, a cooling medium supply step S20, and a cleaning step S30.

The bead formation step S10 is a step of melting the metal material (metal powder 13) with the energy beam 15 while supplying the metal material to form the bead 21. In the bead formation step S10, the linear bead 21 extending along the scanning direction for the manufacturing nozzle 11 is formed on the manufacturing table 9 and the workpiece 20 by melting and solidifying the metal powder 13 supplied onto the manufacturing table 9 and the workpiece 20 while scanning the manufacturing nozzle 11.

The cooling medium supply step S20 is a step of spraying the cooling medium CM from the cooling medium nozzle 60 toward the cooling target region 59 including the bead 21 in the workpiece 20 so that the cooling target region 59 is cooled locally. In the cooling medium supply step S20, the temperature of the cooling target region 59 is reduced by spraying the cooling medium CM toward the workpiece 20 and the bead 21 from the cooling medium nozzle 60 that is scanned along the surface of the workpiece 20, as described above.

Note that, in the cooling medium supply step S20, at least one of the scanning rate of the cooling medium nozzle 60 or the amount of spray per unit time of the cooling medium CM is preferably controlled, as described above, based on the detection result of the temperature of the cooling target region 59 by the temperature sensor 70.

The cleaning step S30 is a step of cleaning the surface of the cooling target region 59 by spraying the cooling medium CM at least toward the cooling target region 59. In the cleaning step S30, the cooling medium CM is sprayed from the cooling medium nozzle 60 toward the surface of the workpiece 20, thereby making it possible to remove and clean a deposit and the like on the surfaces of the workpiece 20 and the bead 21.

According to the three-dimensional manufacturing method using the three-dimensional manufacturing apparatus 1 of some embodiments, the cooling medium CM can be sprayed toward the cooling target region 59, and thus, the time to wait for the temperature of the workpiece 20 to decrease during manufacturing can be shortened, and the production efficiency is improved. In addition, according to the three-dimensional manufacturing method using the three-dimensional manufacturing apparatus 1 of some embodiments, at least one of the scanning rate of the cooling medium nozzle 60 or the amount of the cooling medium CM to be sprayed per unit time is controlled based on the detection result of the temperature of the cooling target region 59. Therefore, the cooling medium MC can be sprayed in a proper amount, the cooling medium CM can efficiently be used, and the cost associated with the cooling medium CM can be suppressed.

According to the three-dimensional manufacturing method using the three-dimensional manufacturing apparatus 1 of some embodiments, the cleaning of the surface of the cooling target region 59 removes the deposit on the surface of the workpiece 20, so that the deterioration in quality of the formed bead 21 can be suppressed.

### (Control of Cooling Rate)

FIG. 10 illustrates a continuous cooling transformation curve (CCT curve) of steel. In the case of various metals without being limited to steel, the cooling rate when cooling the metal to be molten affects mechanical properties, such as strength and toughness, of the metal.

Therefore, in the three-dimensional manufacturing apparatus 1 according to some embodiments, at least one of the scanning rate of the cooling medium nozzle 60 or the amount of the cooling medium CM to be sprayed per unit time is controlled to control the cooling rate of the bead 21 and the workpiece 20, thereby controlling the mechanical properties of the manufactured object 20.

In the three-dimensional manufacturing apparatus 1 according to some embodiments, the control device 100 (supply control unit 103) controls at least one of the scanning rate of the cooling medium nozzle 60 or the amount of the cooling medium CM to be sprayed per unit time based on the detection result from the temperature sensor 70 as the temperature detection unit so as to control the cooling rate of the cooling target region 59.

This allows the mechanical properties of the workpiece or manufactured object 20 to be controlled.

In the three-dimensional manufacturing apparatus 1 according to some embodiments, the plurality of cooling medium nozzles 60 are disposed along the scanning direction 17. Furthermore, in the three-dimensional manufacturing apparatus 1 according to some embodiments, the control device 100 (supply control unit 103) can control at least one of the scanning rate of the cooling medium nozzle 60 or the amount of the cooling medium CM to be sprayed per unit time, based on the detection result from the temperature sensor 70, for each of the cooling medium nozzles 60.

Therefore, according to the three-dimensional manufacturing apparatus 1 according to some embodiments, the control accuracy of the cooling rate is improved, so the control accuracy of the mechanical properties of the manufactured object 20 is improved.

For example, in the case where a relatively high cooling rate is required, as seen in a cooling rate curve L1 and a cooling rate curve L2 in FIG. 10, a relatively large amount of the cooling medium CM is preferably sprayed from all of the rear nozzles 63B toward the cooling target region 59 using the nozzle device 10 as illustrated in FIGS. 7A and 7B.

In the three-dimensional manufacturing apparatus 1 according to some embodiments, the control device 100 (supply control unit 103) can control the amount of the cooling medium CM to be sprayed per unit time so that the amount of the cooling medium CM to be sprayed per unit time from the rear nozzle 63B disposed on a rear side is larger than that from the rear nozzle 63B disposed on a front side, among the plurality of rear nozzles 63B disposed on the rear side of the manufacturing nozzle 11.

For example, if the cooling rate required is low as compared with those in the cooling rate curves L1 and L2 described above, as seen in a cooling rate curve L3 in FIG. 10, the cooling rate tends to be higher because the temperature difference from the atmosphere is relatively large in a state where the temperature of the cooling target region 59 is relatively high. Conversely, if the temperature of the cooling target region 59 is relatively low, the cooling rate tends to be lower because the temperature difference from the atmosphere is relatively small.

Therefore, the amount of the cooling medium to be sprayed per unit time from the rear nozzle 63B disposed on the rear side is made larger than that from the rear nozzle 63B disposed on the front side, and thus the required cooling rate can be ensured even when the temperature of the cooling target region 59 is relatively low.

The present disclosure is not limited to the embodiments described above, and also includes a modification of the above-described embodiments as well as appropriate combinations of these modes.

The contents described in the respective embodiments described above are construed as follows, for example. (1) The three-dimensional manufacturing apparatus 1 according to at least one embodiment of the present disclosure includes the manufacturing nozzle 11 for melting a metal material (metal powder 13) with the energy beam 15 while supplying the metal material to form the bead 21. The three-dimensional manufacturing apparatus 1 according to at least one embodiment of the present disclosure includes the cooling medium nozzles 60 for spraying the cooling medium CM toward the cooling target region 59 so that the region including the bead 21 in the workpiece 20 (cooling target region 59) is cooled locally. The three-dimensional manufacturing apparatus 1 according to at least one embodiment of the present disclosure includes at least the temperature sensor 70 that detects the temperature of the cooling target region 59. Further, the three-dimensional manufacturing apparatus 1 according to at least one embodiment of the present disclosure includes the control device 100 (supply control unit 103) for controlling at least one of the scanning rate of the cooling medium nozzle 60 or the amount of the cooling medium CM to be sprayed per unit time, based on the detection result from the temperature sensor 70.

According to the configuration described in (1) above, the cooling medium CM can be sprayed toward the cooling target region 59, and thus, the time to wait for the temperature of the workpiece 20 to decrease during manufacturing can be shortened, and the production efficiency is improved. Also, according to the configuration described in (1) above, at least one of the scanning rate of the cooling medium nozzle 60 or the amount of the cooling medium to be sprayed per unit time can be controlled based on the detection result from the temperature sensor 70. So, the cooling medium CM can be sprayed in a proper amount, the cooling medium CM can efficiently be used, and the cost associated with the cooling medium CM can be suppressed.

(2) In some embodiments, in the configuration described in (1) above, the control device 100 (supply control unit 103) controls at least one of the scanning rate of the cooling medium nozzle 60 or the amount of the cooling medium MC to be sprayed per unit time based on the detection result from the temperature sensor 70 so as to control the cooling rate of the cooling target region 59.

The cooling rate when cooling the metal to be molten affects mechanical properties, such as strength and toughness, of the metal. According to the configuration described in (2) above, the cooling rate of the cooling target region 59 including the bead 21 in the workpiece 20 can be controlled, and thus the mechanical properties of the workpiece or manufactured object 20 can be controlled.

(3) In some embodiments, in the configuration described in (2) above, the plurality of cooling medium nozzles 60 are disposed along the scanning direction 17. The control device 100 (supply control unit 103) can control at least one of the scanning rate of the cooling medium nozzle 60 or the amount of the cooling medium CM to be sprayed per unit time, based on the detection result from the temperature sensor 70.

According to the configuration described in (3) above, at least one of the scanning rate of the cooling medium nozzle 60 or the amount of the cooling medium CM to be sprayed per unit time can be controlled for each of the cooling medium nozzles 60 disposed along the scanning direction 17, and thus the control accuracy of the cooling rate is improved.

(4) In some embodiments, in the configuration described in (3) above, the control device 100 (supply control unit 103) controls the amount of the cooling medium CM to be sprayed per unit time so that the amount of the cooling medium CM to be sprayed per unit time from the cooling medium nozzle 60 (rear nozzle 63B) disposed on the rear side in the scanning direction is larger than that from the cooling medium nozzle 60 (rear nozzle 63B) disposed on the front side in the scanning direction 17.

If the temperature of the cooling target region 59 is relatively high, the cooling rate tends to be higher because the temperature difference from the atmosphere is relatively large. Conversely, if the temperature of the cooling target region 59 is relatively low, the cooling rate tends to be lower because the temperature difference from the atmosphere is relatively small.

According to the configuration described in (4) above, the amount of the cooling medium CM to be sprayed per unit time from the rear nozzle 63B disposed on the rear side in the scanning direction 17 can be made larger than that from the rear nozzle 63B disposed on the front side in the scanning direction 17, and thus the required cooling rate can be ensured even when the temperature of the cooling target region 59 is relatively low.

(5) In some embodiments, in any one of the configurations described in (1) through (4) above, the cooling medium CM is pellet-shaped or powdery dry ice.

According to the configuration described in (5) above, the dry ice after being sprayed onto the workpiece 20 sublimates quickly after cooling of the workpiece 20, so it is not necessary to wet the workpiece 20 or to worry about the risk that the dry ice may remain as a foreign substance on and around the workpiece 20. In addition, according to the configuration described in (5) above, the dry ice is pellet-shaped or powdery, and thus easily supplied from the cooling medium nozzle 60.

(6) In some embodiments, in any of the configurations described in (1) through (5) above, the nozzle scanning device 30 is further provided for scanning the cooling medium nozzle 60 following the scanning of the manufacturing nozzle 11.

According to the configuration described in (6) above, localized cooling of the cooling target region 59 including the bead 21 can efficiently be performed. Thus, the amount of the cooling medium CM to be consumed can be suppressed.

(7) In some embodiments, in the configuration described in (6) above, the nozzle scanning device 30 can integrally scan the manufacturing nozzle 11 and the cooling medium nozzle 60.

According to the configuration described in (6) above, it is possible to suppress the complication of the device configuration of the nozzle scanning device 30 and the contents of control of the nozzle scanning device 30.

(8) In some embodiments, in the configuration described in (6) above, the nozzle scanning device 30 can individually scan the manufacturing nozzle 11 and the cooling medium nozzle 60.

According to the configuration described in (7) above, even if the scanning rates required for the manufacturing nozzle 11 and the cooling medium nozzle 60 are different, the nozzles can be scanned at scanning rates appropriate for the respective nozzles.

(9) In some embodiments, in any of the configurations described in (6) through (8) above, the nozzle scanning device 30 includes the robot arm 5.

For example, in the case where the manufacturing nozzle 11 is scanned using a device having a slide shaft that is movable in each direction of the X, Y, and Z axes, such as an NC device, the size of the workpiece 20 is restricted by the size of the device. In addition, in the device, the degree of freedom of the posture of the manufacturing nozzle is restricted by a drive system configuration.

According to the configuration described in (9) above, the manufacturing nozzle 11 can be scanned using the robot arm 5, thereby making it easy to scan the manufacturing nozzle 11 in a wide range, as compared with the device, even if the robot arm 5 is relatively compact. Additionally, according to the configuration described in (9) above, the degree of freedom of the posture of the manufacturing nozzle 11 is increased, thereby making it easy to manufacture even a manufactured object 20 having a complex shape.

(10) In some embodiments, in any of the configurations described in (1) through (9) above, the manufacturing nozzle 11 has the blowout unit 110 for the shielding gas SG. In some embodiments, the shielding mechanism 40 for suppressing diffusion of the shielding gas SG is further provided.

According to the configuration described in (10) above, the bead 21 can be formed under the shielding gas SG atmosphere.

(11) In some embodiments, in the configuration described in (10) above, the shielding mechanism 40 includes the airflow curtain formation unit 41 for forming an airflow curtain that suppresses diffusion of the shielding gas SG by a flow of gas.

According to the configuration described in (11) above, diffusion of the shielding gas SG can be suppressed by the airflow curtain. Thus, even if the shape of the workpiece 20 is complex, the atmosphere of the region for forming the bead 21 (forming region 25) is easily maintained to be the shielding gas SG atmosphere.

(12) In some embodiments, in the configuration described in (10) or (11) above, the shielding mechanism 40 includes the cover member 43 that is so disposed as to surround the blowout unit 110 from its surroundings when viewed along the direction of irradiation with the energy beam 15 emitted from the manufacturing nozzle 11.

According to the configuration described in (12) above, the diffusion of the shielding gas SG by the cover member 43 is suppressed, so the atmosphere of the region (forming region 25) that forms the bead 21 is easily maintained in the shielding gas SG atmosphere.

(13) In some embodiments, in any of the configurations described in (10) through (12) above, the blowout unit 110 includes the first blowout unit 111 configured to blow out the shielding gas SG from the tip end of the manufacturing nozzle 11 (tip end part 11a) and the second blowout unit 121 disposed on the side of the manufacturing nozzle 11 and configured to blow out the shielding gas SG.

According to the configuration described in (13) above, the shielding gas SG is blown out from the tip end of the manufacturing nozzle 11 and the side of the manufacturing nozzle 11, thereby making it easy to maintain the atmosphere of the region for forming the bead 21 (forming region 25) to be the shielding gas SG atmosphere.

In the case where the powdery metal material is configured to be supplied from the tip end of the manufacturing nozzle 11, if the amount of the shielding gas SG to be blown out from the tip end of the manufacturing nozzle 11 is increased, there is a risk that the metal material (metal powder 13) prior to melting may diffuse to surroundings, together with a flow of the shielding gas SG hitting on the surface of the workpiece 20 and being about to diffuse to the surroundings. Therefore, it is desirable to suppress the amount of the shielding gas SG to be blown out from the tip end of the manufacturing nozzle 11. However, if the amount of the shielding gas SG to be blown out from the tip end of the manufacturing nozzle 11 is suppressed, there is a risk that the atmosphere of the region for forming the bead 21 (forming region 25) may be less likely to be maintained to be the shielding gas SG atmosphere. According to the configuration described in (13) above, the shielding gas SG can be blown out also from the side of the manufacturing nozzle 11, thereby making it easy to maintain the atmosphere of the region for forming the bead 21 (forming region 25) to be the shielding gas SG atmosphere even if the amount of the shielding gas SG to be blown out from the tip end of the manufacturing nozzle 11 is suppressed.

(14) The three-dimensional manufacturing method according to at least one embodiment of the present disclosure includes the step of melting the metal material (metal powder 13) with the energy beam 15 while supplying a metal material to form the bead 21 (bead formation step S10). The three-dimensional manufacturing method according to at least one embodiment of the present disclosure includes the step of spraying the cooling medium CM from the cooling medium nozzle 60 toward the cooling target region 59 so that the region including the bead 21 in the workpiece 20 (cooling target region 59) is cooled locally (cooling medium nozzle supply step S20). The step of spraying the cooling medium (cooling medium supply step S20) involves controlling at least one of the scanning rate of the cooling medium nozzle 60 or the amount of the cooling medium CM to be sprayed per unit time based on the detection result of the temperature of the cooling medium region 59.

According to the method described above (14), the cooling medium CM can be sprayed toward the cooling target region 59, and thus, the time to wait for the temperature of the workpiece 20 to decrease during manufacturing can be shortened, and the production efficiency is improved. Also, according to the method described in (14) above, at least one of the scanning rate of the cooling medium nozzle 60 or the amount of the cooling medium CM to be sprayed per unit time is controlled based on the detection result of the temperature of the cooling target region 59. So, the cooling medium CM can be sprayed in a proper amount, the cooling medium CM can efficiently be used, and the cost associated with the cooling medium CM can be suppressed.

(15) In some embodiments, the method described in (14) above further includes the step of cleaning the surface of the cooling target region 59 by spraying the cooling medium CM at least toward the cooling target region 59 (cleaning step S30).

According to the method described in (15) above, the cleaning of the surface of the cooling target region 59 removes the deposit on the surface of the workpiece 20, so that the deterioration in quality of the formed bead 21 can be suppressed.

While preferred embodiments of the invention have been described as above, it is to be understood that variations and modifications will be apparent to those skilled in the art without departing from the scope and spirits of the invention. The scope of the invention, therefore, is to be determined solely by the following claims.

1. A three-dimensional manufacturing apparatus comprising:
a manufacturing nozzle for melting a metal material with an energy beam while supplying the metal material to form a bead;
a cooling medium nozzle for spraying a cooling medium toward a region including the bead in a workpiece so that the region is cooled locally;
a temperature detection unit configured to detect at least a temperature of the region; and
a control device for controlling at least one of a scanning rate of the cooling medium nozzle or an amount of the cooling medium to be sprayed per unit time based on a detection result from the temperature detection unit.

2. The three-dimensional manufacturing apparatus according to claim 1, wherein the control device controls at least one of the scanning rate of the cooling medium nozzle or the amount of the cooling medium to be sprayed per unit time based on the detection result from the temperature detection unit so as to control a cooling rate of the region.

3. The three-dimensional manufacturing apparatus according to claim 2,
wherein a plurality of the cooling medium nozzles are disposed along a scanning direction, and
wherein the control device controls, for each of the cooling medium nozzles, at least one of the scanning rate of the cooling medium nozzle or the amount of the cooling medium to be sprayed per unit time based on the detection result from the temperature detection unit.

4. The three-dimensional manufacturing apparatus according to claim 3, wherein the control device controls the amount of the cooling medium to be sprayed per unit time so that the amount of the cooling medium to be sprayed per unit time from the cooling medium nozzles disposed on a rear side in the scanning direction is larger than that to be sprayed per unit time from the cooling medium nozzles disposed on a front side in the scanning direction.

5. The three-dimensional manufacturing apparatus according to claim 1, wherein the cooling medium is pellet-shaped or powdery dry ice.

6. The three-dimensional manufacturing apparatus according to claim 1, further comprising:
a nozzle scanning device for scanning the cooling medium nozzle, following scanning of the manufacturing nozzle.

7. The three-dimensional manufacturing apparatus according to claim 6, wherein the nozzle scanning device can integrally scan the manufacturing nozzle and the cooling medium nozzle.

8. The three-dimensional manufacturing apparatus according to claim 6, wherein the nozzle scanning device can individually scan the manufacturing nozzle and the cooling medium nozzle.

9. The three-dimensional manufacturing apparatus according to claim 6, wherein the nozzle scanning device includes a robot arm.

10. The three-dimensional manufacturing apparatus according to claim 1,
wherein the manufacturing nozzle has a blowout unit for a shielding gas, and further comprises a shielding mechanism for suppressing diffusion of the shielding gas.

11. The three-dimensional manufacturing apparatus according to claim 10, wherein the shielding mechanism includes an airflow curtain formation unit configured to form an airflow curtain that suppresses diffusion of the shielding gas by a flow of gas.

12. The three-dimensional manufacturing apparatus according to claim 10,
wherein the shielding mechanism includes a cover member that is so disposed as to surround the blowout unit from its surroundings when viewed along a direction of irradiation with the energy beam emitted from the manufacturing nozzle.

13. The three-dimensional manufacturing apparatus according to claim 10, wherein the blowout unit includes a first blowout unit configured to blow out the shielding gas from a tip end of the manufacturing nozzle, and a second blowout unit disposed on a side of the manufacturing nozzle and configured to blow out the shielding gas.

14. A three-dimensional manufacturing method, comprising steps of:
melting a metal material with an energy beam while supplying the metal material to form a bead; and
spraying a cooling medium from a cooling medium nozzle toward a region including the bead in a workpiece so that the region is cooled locally;
wherein, in the step of spraying the cooling medium, at least one of a scanning rate of the cooling medium nozzle or an amount of the cooling medium to be sprayed per unit time is controlled based on a detection result of the temperature of the region.

15. The three-dimensional manufacturing method according to claim 14, further comprising a step of:
cleaning a surface of the region by spraying the cooling medium at least toward the region.
